(19) United States
(12) Patent Application Publication
(10) Pub. No.: US 2018/0096412 A1
(43) Pub. Date: Apr. 5, 2018

(54) DIGITAL BROKERAGE SERVICE FOR IOT MICRO COMPUTE SERVICES

(71) Applicants: Mark E. Scott-Nash, Arvada, CO (US); Howard C. Herbert, San Tan Valley, AZ (US)

(72) Inventors: Mark E. Scott-Nash, Arvada, CO (US); Howard C. Herbert, San Tan Valley, AZ (US)

(21) Appl. No.: 15/282,719

(22) Filed: Sep. 30, 2016

(51) Int. Cl. G06Q 30/06; H04L 29/06; G06Q 20/12

(52) U.S. Cl. CPC G06Q 30/0635; G06Q 20/123; H04L 63/0428; H04L 63/20

(57) ABSTRACT

In some embodiments, the disclosed subject matter involves a digital brokerage service to match data, services and compute capacity of subscribers and publishers in a trusted execution environment (TEE). In an embodiment, data is generated by an Internet of Things IoT device. Publishers register available resources with the digital brokerage service, including TEE capabilities. Subscribers request data or services with a quality of service or service level agreement requirements and define required TEE capabilities. Other embodiments are described and claimed.

### TECHNICAL FIELD

An embodiment of the present subject matter relates generally to computer networking, and more specifically, to providing a digital brokerage service for Internet of Things (IoT) micro compute services.

### BACKGROUND

Various architectures exist for sharing resources and providing services to users and entities. Time-sharing and batch processing resources has been in place since the early days of computing. However, past and existing methods and architectures have a variety of disadvantages and may not work well with newer technologies, such as Internet of Things (IoT).

A newer architectural term, which brings resource sharing into the 21st Century, is “Micro Service Architecture.” This new term describes a particular way of designing software applications as suites of independently deployable services. While there may be no precise definition of this architectural style in the industry, yet, there are certain common characteristics around organization around business capability, automated deployment, intelligence in the endpoints, and decentralized control of languages and data. More information may be found in a paper entitled, Microservice, by James Lewis and Martin Fowler, 25 Mar. 2014, at URL martinfowler*com/articles/microservices.html. It should be noted that periods have been replaced with asterisks in URLs in this document to avoid inadvertent hyperlinks.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a high level block diagram showing an example digital brokerage service (DBS), according to an example embodiment.

FIG. 2 is a block diagram showing a general structure of data use controls (DUC) and micro compute service (MCS) agents, according to an embodiment.

FIG. 3 is a block diagram showing general structure and flow of an example micro compute service, according to an embodiment.

FIG. 4 block diagram showing a general flow of data objects and code objects using a micro compute services (MCS) agent, according to an embodiment.

FIG. 5 is a block diagram showing an example digital brokerage service with subscribers and publishers, ensuring trusted execution environments, according to an example embodiment.

FIG. 6 is a block diagram illustrating an example subscriber micro compute service package, according to an embodiment.

FIG. 7 is a flow diagram illustrating how various actors and devices interact within the digital brokerage service, according to an embodiment.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appealing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

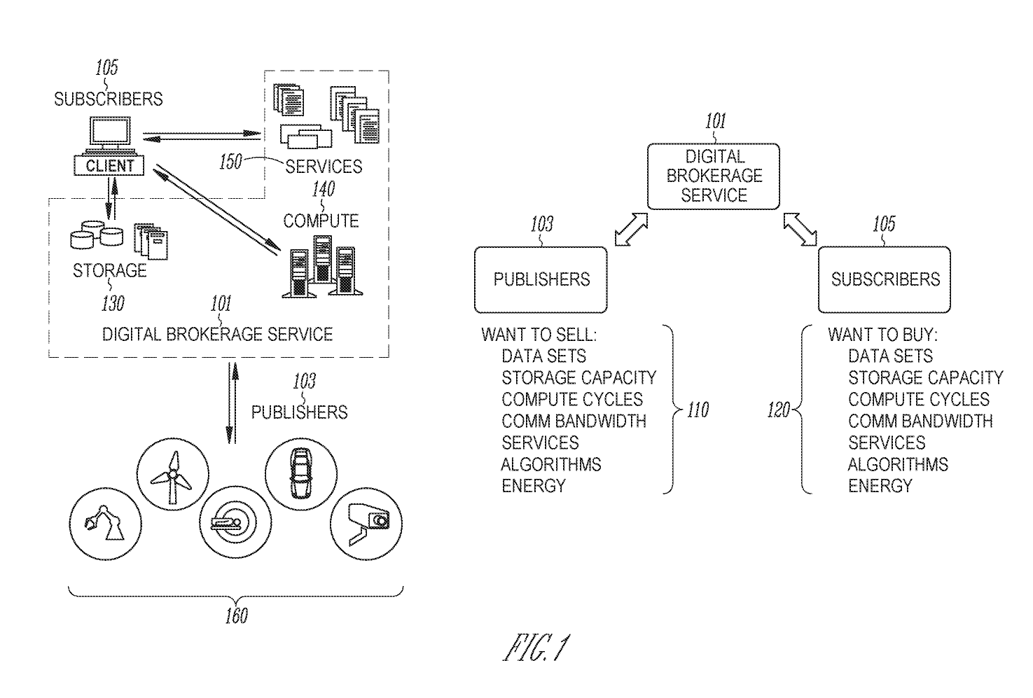

Referring to FIG. 1, an embodiment of the present subject matter is a system and method relating to a digital brokerage service (DBS) 101 for brokering data and service between and among publishers 103 and subscribers 105. A publisher 103 may publish, or provide, any number of data, services, bandwidth, storage capacity, compute capacity, algorithms, or energy, 110, for example. A subscriber 105 may desire to use any of the resources 120 made available by a publisher. In at least one embodiment, the DBS 101 described herein, enables analysis of large data sets on localized compute resources to reduce data transfer issues, as well as to provide security, privacy, and comply with geographic data transfer regulations (e.g., citizen medical or other personal data not allowed to be transferred out of the country). In an embodiment, the DBS may broker storage capacity 130, compute nodes 140, and services 150. In an embodiment, a large data set is derived from sensors on an IoT enabled device, such as an automobile, a video device (e.g., a security camera or nanny cam), industrial equipment, wearable devices, actuators, etc. 160.

Traditional cloud computing and timesharing techniques brought the data to the data center for processing. This model may not be feasible in many IoT or similar applications, for instance when the IoT device does not have sufficient broadband capacity, or other constraints prevent the movement of the data. A newer micro compute services paradigm brings the data center processing to the data, but may also have privacy, security, as well as geographic, boundary restrictions.

Though edge devices are expected to lag in processing performance, the constraints highlighted above will drive data processing closer to the edge where it is expected that “local clouds” of processing will be deployed. These local clouds will provide “micro compute services,” essentially the ability to process data locally based on a generated request.

Local clouds may offer a service provided independently from the IoT data owner and there may be several hierarchical levels of clouds and processing ability. These clouds may request micropayments for services rendered.

In an embodiment, a DBS for micro compute services facilitates transactions between IoT data generators and local cloud data center providers. The DBS may seamlessly match subscribers of services and publishers of publisher services. Embodiments may enforce privacy and security of code and data by utilizing cryptographic mechanisms and Trusted Execution Environment (TEE) technology.

In an embodiment, data generated by an IoT device or system (data objects) may be digitally signed and encrypted by the owner, or publisher, using symmetric and asymmetric keying material per industry standards (e.g., JSON security extensions). A use policy may be created and digitally signed by the data owner, as well. Policy and protected data objects may be stored (published) and identified via a public and persistent identification architecture such as the IETF/CNRI Digital Object Architecture (DOA) using Digital Object Identifiers (DOI). A digital brokerage service (DBS) 101 may “buy” data from publishers and “sell” data to subscribers. The DBS may also enable publishers and subscribers to buy and sell directly to one another. This latter service may implement cryptographic key management between a publisher and subscriber rather than handle the actual data.

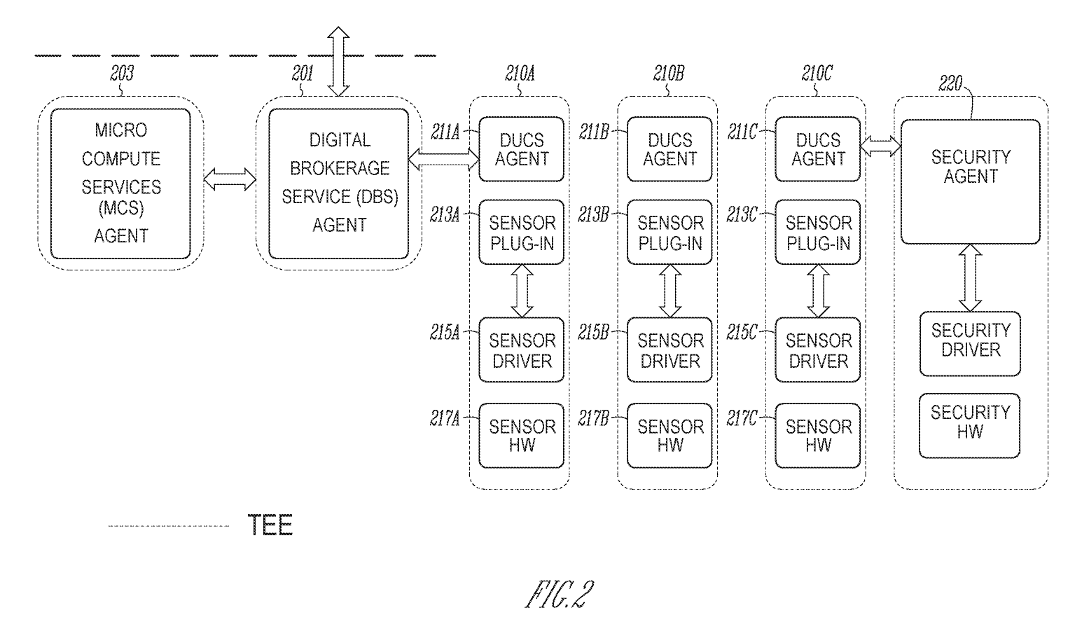

Referring to FIG. 2, a block diagram of an example data use control (DUC) agent is shown as used with a digital brokerage service (DBS) agent. The dotted lines around a module, agent or component, indicates that the module, agent or component executes within a Trusted Execution Environment (TEE). Thus, a DBS agent 201 exists in an attestable TEE such as Software Guard Extensions (SGX) or TrustLite (TLT) available from Intel Corporation, TrustZone® available from ARM®, or similar trusted execution environment.

In an embodiment, the buying and selling of resources and data may be effected by a particular device in the system having a DBS agent 201. A sensor stack 210a-c may be seen as having sensor hardware at the bottom 217a-c and associated sensor driver 215a-c. The sensor driver 215a-c may communicate with a sensor plug-in 213a-c. A given sensor stack 210a-c, whether it be temperature, performance or other sensor data, may have a data use control (DUC) agent 211a-c. A policy-defined amount of data generated from each sensor in the stack may be identified as a digital object for that sensor, and each collected digital object will be assigned a digital object identifier (DOI). A digital object may also assigned access rights, provenance, and other metadata (e.g., collection date/time/geo and duration specifics). In an embodiment, data and metadata may be encoded using JSON (JavaScript Object Notation) text data interchange language standard format. The data may then be secured using JSON-defined security mechanisms (digital signature and encryption). If required, compression algorithms may be applied. Other interchange languages may be used, for instance, XML. It will be understood that other standards may be used as alternatives for the text data interchange language.

A device may also have a security agent 220 to perform the security processing on the data associated with any specific sensor stack. In an embodiment the DBS and DUC agents, sensor stacks, and security agent stack all reside within distinct TEEs.

Once a number of data objects have been generated, they may be made available to the DBS, by the publisher. A subscriber may want to run analytics code on the generated data objects in various embodiments, the publisher and subscriber may be the same entity or node, or separate entities. In an embodiment, a subscriber desires to use data objects generated by another, and may or may not own or provide the data processing resources needed to run the desired analytics code. In another embodiment, the owner of the data objects desires to run analytics code on their own data objects, but do not own the analytics data processing resources. An embodiment assists subscribers of the data objects in obtaining the analytics code execution service to be communicatively coupled with the data, either on the node where the data resides, or another localized node. For instance, if the data object is IoT data from an automobile, it may be required that the automobile to be coupled to a WiFi or hard-wired communication system, or LAN, to offload the data from the automobile to a more accessible storage device on a compute node. Future 5G communication systems may alleviate some of the transmission bandwidth problems, but geographic or geo-fenced security restrictions may still prohibit transfer of some types of data objects to certain data centers. In an embodiment, a subscriber may use the platform on which a data object was collected to run the analytics code execution service, or on a platform close to the edge. In an embodiment the DBS matches the subscriber's analytics code, for instance, to the licensed data set, along with a platform on which to run the analytics.

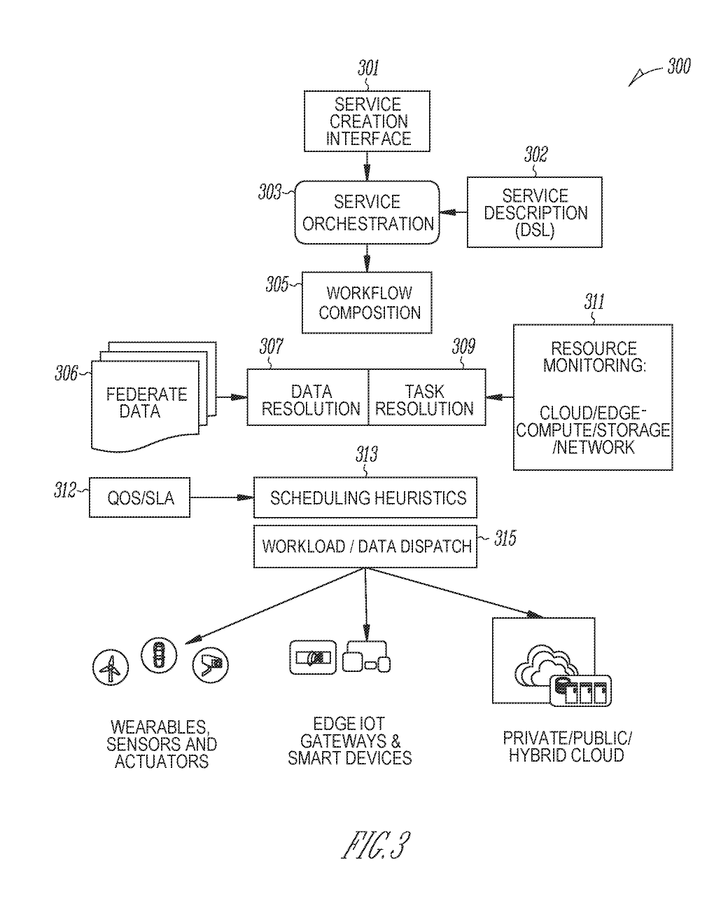

Referring to FIG. 3, there is shown a block diagram of a micro compute service (MCS) 300 portion of a DBS 101, according to an embodiment. Security sensitive portions of the micro compute service (MCS) 300 resides within a TEE. The MCS identifies those trusted environments that are compatible with subscriber and publisher code and data object security requirements. The MCS includes a service creation interface 301 which a subscriber uses to input service requests into the MCS. The MCS has ensembles of resources and resource pooling available for use by subscriber workloads. The service orchestration component 303 utilizes a service description language 302 to help define the scope of the service to be executed, including available resources and necessary security protocols/environments. Once the parameters of the service are understood and defined by the service orchestration component, a workflow composition component 305 determines the location of required code and data objects with the help of the data resolution component 307, and associated Federated data 306. The workflow composition component 305 also determines the location of suitable execution environments with the help of task resolution component 309 and resource monitoring component 311. For instance, the resource monitoring component 311 may identify resources from the cloudledge for compute, storage, or network communication resources, etc. In an example, a subscriber analytics workload may be split among more than one compute node and execute in a distributed fashion, either in parallel or serially, or combination.

Once the data and task resolution operations are completed, a scheduling heuristic component 313 may be used to finalize the binding between resources. The scheduling heuristics may utilize quality of service (QoS) and Service Level Agreement (SLA) parameters 312 to assist with the binding. The scheduling heuristic may also use information about how much a subscriber is willing to spend on a service, and how much a publisher is charging to execute the workload. Additionally, a parameter in the service request may require a trusted environment, a specific trusted environment or encryption level, geographic preference or prohibition, etc. This may be defined with the QoS parameters 312.

Once the match has been made, based on request criteria, including QoS and SLA enforcement, the workload and/or data is dispatched by the dispatcher module 315 to the selected compute resource, or workload node. The match may be fully automatic after the scheduling heuristics 313 matches data, services, and compute node, etc. A remote attestation module, to be described below, may be used to complete the match. In an embodiment, the remote attestation module ensures that a TEE is present when required, and enables provisioning the code and data to the matched trusted environment(s).

It will be understood that in an embodiment, both subscriber nodes and publisher nodes will include agents to communicate with the DBS over a network, for instance either the public Internet or a private intranet.

In an example scenario, a subscriber may send a query about the data set directly on a micro compute service portal. In another scenario, the subscriber may have analytics code that they wish to use to analyze the data set. In an embodiment, the DBS may find an appropriate micro compute services portal to run the required analytics code. In many cases, the analytics code may contain substantial subscriber intellectual property or proprietary data, and will be protected using the same cryptographic mechanisms as data objects (i.e., digital signatures and encryption). The owner of the data objects may not be the same as the owner of the analytics code. Thus, in an embodiment, the DBS treats the analytics code as another object type and assigns it a DOI, access rights, provenance, and other metadata similar to data objects, as described above.

Referring again to FIG. 2, a micro compute services (MCS) agent 203 on a node communicates with the DBS agent 201. The MCS agent 203 may monitor device resources on the node and securely advertise its capabilities to the DBS agent 201, The MCS agent 203 may facilitate secure downloading of workloads for execution. A workload may include code objects and data objects, and may also include the operating state if it is a migrating workload. The MCS agent 203 may further control and monitor job execution progress, including start, stop, resume, and migrate functions. The MCS agent 203 may also facilitate secure uploading of workload results (as new data objects) and workload state to a location accessible to the subscriber.

In an embodiment, when a subscriber licenses data objects from a publisher via the DBS, the subscriber obtains cryptographically bound digital receipts granting access to the data objects as prescribed by the publisher's policy. A receipt may also be generated by the DBS that contains a DOI for the trusted loader code that both parties agree to use in the Trusted Execution Environment.

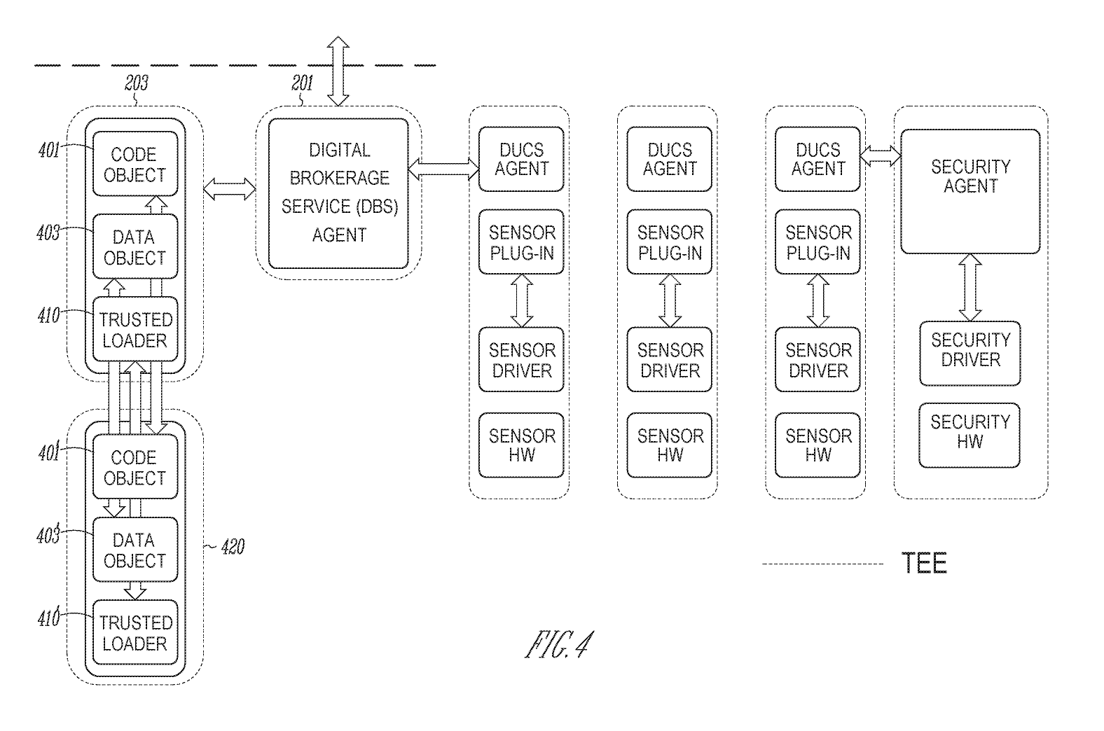

Referring now to FIG. 4, additional details of the micro compute services (MCS) agent of FIG. 2 are shown, according to an embodiment. In an embodiment, the MCS agent uses digital receipt DOIs to obtain the trusted loader 410 code object, analytics code object 401, and data object 403 from the DBS. The first code loaded by the MCS agent into TEE 42.0 is the trusted loader 410. This code may be loaded without any security mechanisms (i.e., in the clear). The DBS then asks the TEE to provide an attestation. Once the remote attestation is validated, the DBS provisions the necessary object decryption keys via the MCS agent to the trusted loader 410’ code. Once in place, the MCS agent loads, using the trusted loader 410′, the analytics code object 401, and data object 403, into the TEE 420 as 401′ and 403′, respectively. Trusted loader 410′ code then decrypts the objects, validates their digital signatures, and then enforces the provided policy (i.e., allows the analytics code object to run against the data objects). By utilizing the TEE and attestation, both the code objects and data objects are protected.

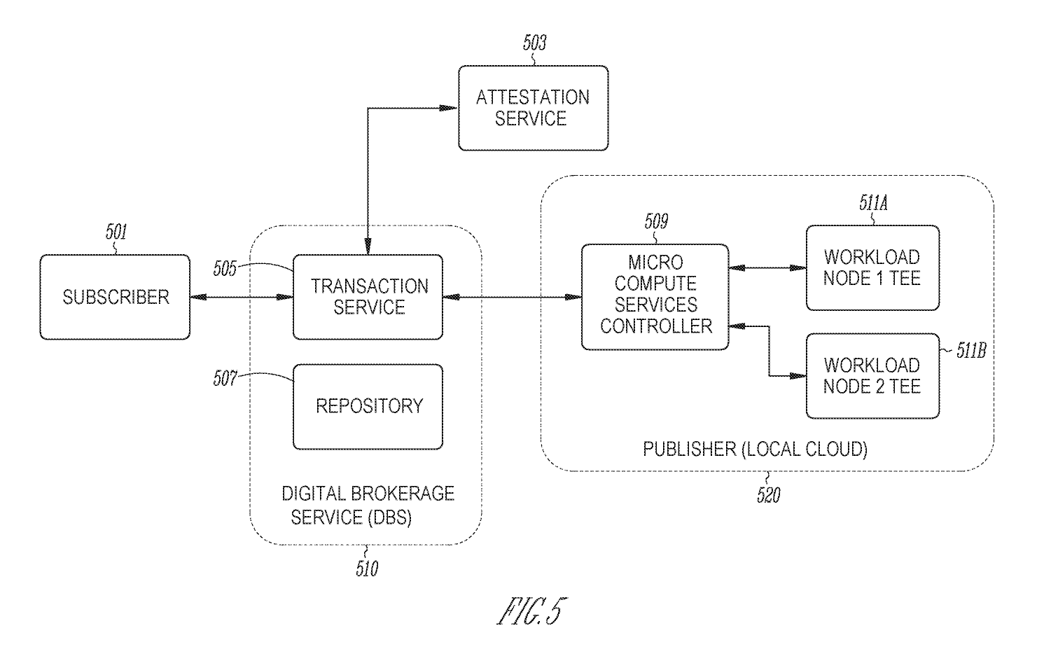

Referring to FIG. 5, there is shown a high level block diagram of a digital brokerage service (DBS) server or node, for micro compute services architecture, according to an embodiment, as discussed above. A subscriber 501 may be an edge device, node or network in need of data processing services from a local cloud. A publisher 520 may be a local cloud or node that can provide the requested services. In an embodiment, the publisher 520 may be any one of a variety of device types. Even a small IoT device may be used as a micro compute services controller, or node, 509 as long as it has a MCS agent 203 and a DBS agent 201 within a TEE to communicate with the DBS 510 to match data, services, and resources. The DBS 510 matches subscriber 501 and publisher 520 using transaction service 505. In an embodiment, the transaction service 505 may perform the heuristic matching, as well as communicate with a remote attestation service 503 to ensure that data, services and resources are appropriately matched based on security requirements and capabilities. The attestation service 503 may be used to verify that the publisher 520 is operating with an acceptable TEE, and that proprietary data or code are appropriately encrypted for transfer, etc. in one or more embodiments, there may be numerous subscribers and publishers and prices for services and/or data may be competitively negotiated by the DBS.

In an embodiment, the publisher 520 includes logical entities of the micro compute services controller 509, and at least one workload node 511. This example shows two nodes 511a-b, but it will be understood that more than two workload nodes 511 may be available. The micro compute services controller 509 coordinates service response, and the workload nodes 511 provide attestable TEEs to run subscriber workloads in a protected and private environment. In an embodiment, the TEE may be an application running within an Intel® SGX enclave or a measured virtual machine environment using Intel VT-x with an underlying, measured hypervisor enforcing memory access protections. Other embodiments may use alternative implementations of trusted execution environments.

In embodiments, micro compute services may be fixed or moveable. A publisher 520 may have fixed algorithms expected to run in the publisher environment, for example because the code or algorithm is proprietary, or too large to be mobile. A moveable service is an algorithm that may be uploaded from the DBS repository 507 or from the subscriber 501 itself. These algorithms may be encrypted during the transfer process and only decrypted and executed within the workload TEE environment, thus remaining protected and private to the subscriber.

In an embodiment, the attestation service 503 may utilize local processes as well as the control process. For instance, the MCS agent 203 (executing within the micro compute service controller 509) may include a local attestation agent on the local device. This local attestation agent may be a combination of hardware and firmware or other TEE code that is protected. The main attestation control process may be part of the main DBS 510 or be contracted out to a third party. The micro compute services controller 509 needs to know whether attestation succeeds, but the attestation may be performed on another device or service.

In an embodiment, the DBS 510 includes a repository 507 accessed via a DOI, as described above. Services registered in the repository 507 may be identified by the subscriber 501 for use in the workload TEE 511. Data that may have been stored in the repository may also be brokered and accessed for processing. In an embodiment, the repository 507 may store both registered data and code, each identified by a DOI.

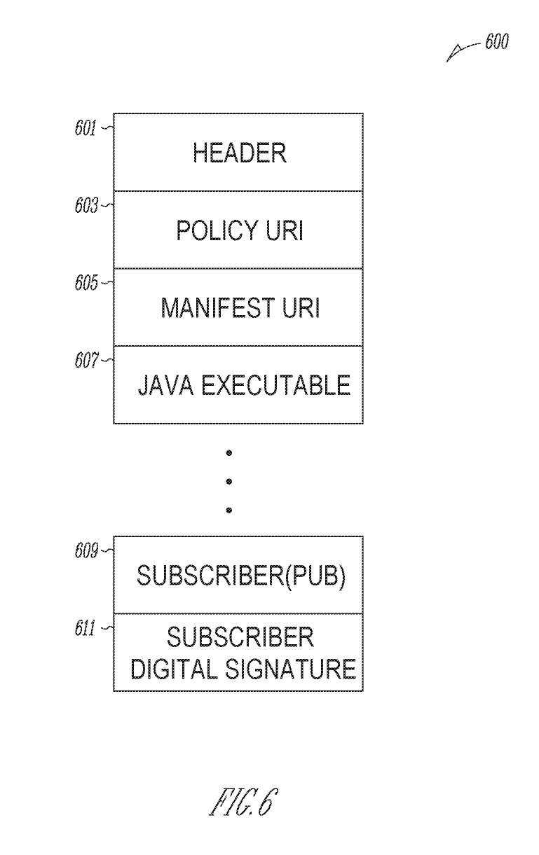

Referring to FIG. 6, there is shown an example subscriber micro compute service package block 600. In an embodiment, subscriber 501 sets up an account on the DBS and submits requests to the DBS via a “package” 600. In an embodiment, the subscriber micro compute service package 600 has a header 601 to identify its contents. The package 600 may include uniform resource identifiers (URIs) for: an execution policy 603 or a service manifest 605; subscriber-unique services in the form of encrypted universal code such as JAVA 607; the subscriber public key 609; and a subscriber digital signature of the package 611. The package may include other parameters, fields or executables, as required.

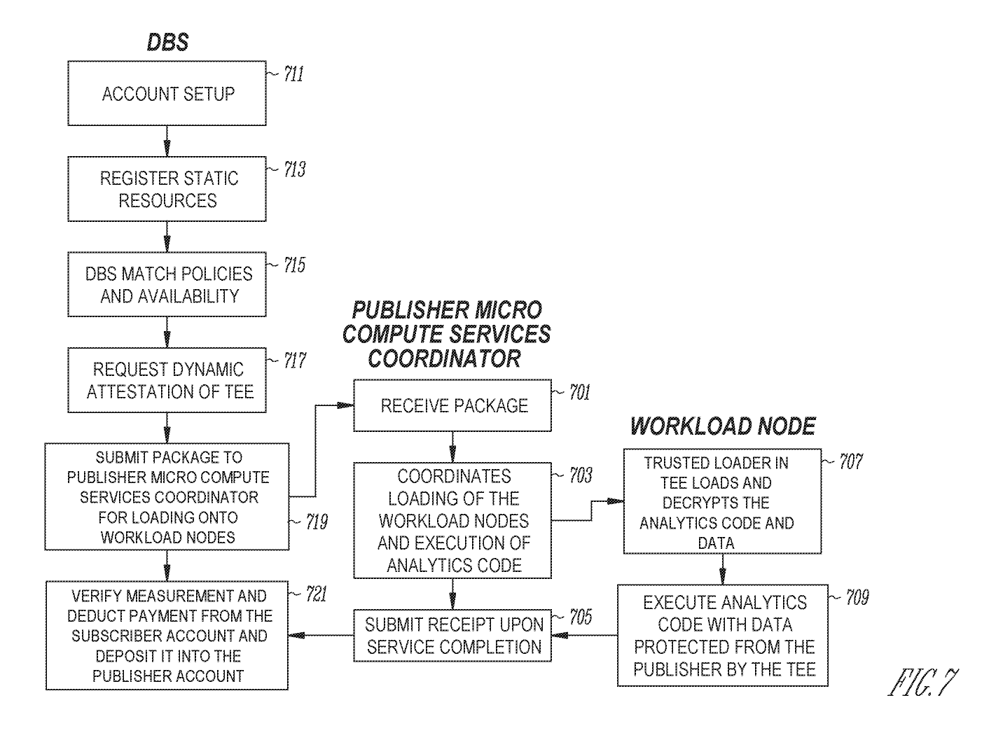

FIG. 7 is an example flow diagram of how the data and services may be brokered, according to an embodiment. In an embodiment, a publisher sets up an account with the DBS at 711, and registers “static” resources available at 713, such as performance, nodes, communication channels, storage, etc., and TEE parameters. The DBS matches subscriber execution policies submitted in the request package with publisher static service availability (which includes price) at 715. Once a match is made, the DBS then requests a dynamic attestation of the environment TEEs at 717 to ensure availability of “clean” nodes. The DBS then submits the package to the publisher micro compute services coordinator on a publisher node at 719.

The publisher micro compute services coordinator receives the package from the DBS at 701, and then coordinates loading of the workload node and execution of analytics code at 703. The workload node will have a trusted loader (410) executing in the measured TEE which can then load and decrypt the analytics code at 707 and begin execution in a private and protected environment from the publisher at 709.

When the service is complete, the publisher micro compute services coordinator may transmit a receipt to the broker at 705. Included in this receipt may be a cryptographically verifiable trusted compute measurement (TCM) as described in patent application Ser. No. 14/977,952. A TCM may measure actual usage of a resource. It will be understood that various methods may be used to measure and report on the resource usage, and the measurement may be encrypted, or use a signature, to ensure accurate billing and payment for the resource usage. The measurement may be verified by the DBS at 721. The DBS may then deduct payment from the subscriber account and deposit it into the publisher account. It will also be understood that the DBS may run within an intranet, or other private or restricted network, where data and services need to be protected, but that individual payments are not required; thus, omitting the payment tasks.

It should be noted that the DBS may broker one or more of the following: data, services and resources. In some cases, the data owner may be the subscriber, and in other cases, the subscriber may be the service provider, requesting data for processing. In some cases, the data owner also has the resources to execute the service, but needs to be matched with a third party provider of analytics code. The publisher may provide data, resources, or the service. The subscriber packages define the needs, and the publisher accounts define what can be provided. In some embodiments, the data service, and resource providers may be any combination of one or more nodes, and services, data and compute resources may be distributed among one or mode nodes.

### ADDITIONAL NOTES AND EXAMPLES

Examples can include subject matter such as a method, means for performing acts of the method, at least one machine-readable medium including instructions that, when performed by a machine cause the machine to performs acts of the method, or of an apparatus or system for digital brokerage services, according to embodiments and examples described herein.

Example 1 is a system for brokering digital services, comprising: a digital brokerage service server which is communicatively coupled to a network when in operation, the digital brokerage service server to heuristically match a subscriber node with at least one of a plurality of publisher nodes, based on the publisher node capabilities, to ensure that services and data provided remain in a trusted execution environment according to policies required by the subscriber node; a repository, coupled to the digital brokerage service server when in operation, to hold information received from the plurality of publisher nodes that identify each of the publisher node capabilities and resources offered; and a transaction service to: communicate with an attestation service to ensure that the subscriber node and the at least one of the plurality of publisher nodes use a compatible and adequate trusted execution environment, and effect the matching of data, services and compute to a workload node having the compatible and adequate trusted execution environment.

In Example 2, the subject matter of Example 1 optionally includes wherein the digital brokerage service server is further to: accept a request from the subscriber node on the network; and identify available resources from the plurality of publisher nodes on the network.

In Example 3, the subject matter of Example 2 optionally includes wherein the request from subscriber node comprises a subscriber micro compute service package including a header, a plurality of uniform resource identifiers, an executable portion, a key for encryption or decryption, and a signed digest of the subscriber micro compute service package.

In Example 4, the subject matter of Example 3 optionally includes wherein the subscriber micro compute service package further includes an execution policy.

In Example 5, the subject matter of Example 4 optionally includes wherein the execution policy identifies a quality of service required by the subscriber node.

In Example 6, the subject matter of Example 5 optionally includes wherein the quality of service identifies a minimum level for the compatible and adequate trusted execution environment, to be run by the workload node.

In Example 7, the subject matter of any one or more of Examples 3-6 optionally include wherein the digital brokerage service server is to facilitate payment for data and services according to a subscriber policy in the subscriber micro compute service package, and the information in the repository.

In Example 8, the subject matter of any one or more of Examples 1-7 optionally include wherein to heuristically match the subscriber node with the at least one of a plurality of publisher nodes, comprises the digital brokerage service server to match to at least two separate publisher nodes wherein a first publisher node offers compute capacity in a trusted execution environment, and a second publisher node offers data to be securely transferred to the trusted execution environment,

In Example 9, the subject matter of any one or more of Examples 1-8 optionally include wherein the transaction service is further to match data with services based on at least one of: scope of service required, data usage, quality of service requirements, service level agreement constraints, costs, budget, or trusted execution environment requirements.

Example 10 is a method of brokering digital services, comprising: accepting by a digital brokerage service node, information from a publisher node to identify resources offered by the publisher node; storing into a repository, information associated with the resources offered by the publisher node; receiving a request from a subscriber node; heuristically matching data, services and compute resources available from a plurality of publisher nodes, as identified in the repository, to respond to the request received, further to ensure that the matched data, services and compute resources are consistent with a trusted execution environment requirement identified in the request; and provisioning data and/or code over a network to a micro compute services controller for service of the request in a trusted execution environment on a workload node, wherein the micro compute services controller comprises a micro compute services agent for provisioning the data or code to the workload node.

In Example 11, the subject matter of Example 10 optionally includes receiving notification from the micro compute services agent that the service has been completed; and verifying measurement and deducting payment from a payment account of the subscriber node and depositing it into a payment account of the publisher node.

In Example 12, the subject matter of any one or more of Examples 10-11 optionally include wherein the information from the publisher node is sent to the digital brokerage service node by a micro compute service agent coupled to the publisher node, the information including criteria for execution within a trusted execution environment.

In Example 13, the subject matter of any one or more of Examples 10-12 optionally includes sending a request for attestation to a remote attestation service to ensure that criteria for execution within a trusted execution environment on the workload node meets requirements received in the request from a subscriber node.

Example 14 is at least one computer readable storage medium having instructions stored therein, the instructions when executed to cause a machine to: accept by a digital brokerage service node, information from a publisher node to identify resources offered by the publisher node; store into a repository, information associated with the resources offered by the publisher node; receive a request from a subscriber node; heuristically match data, services and compute resources available from a plurality of publisher nodes, as identified in the repository, to respond to the request received, further to ensure that the matched data, services and compute resources are consistent with trusted execution environment requirements identified in the request; and provision data and/or code over a network to a micro compute services controller for service of the request in a trusted execution environment on a workload node, wherein the micro compute services controller comprises a micro compute services agent for provisioning the data or code to the workload node.

In Example 15, the subject matter of Example 14 optionally includes instructions to: receive notification from the micro compute services agent that the service has been completed; and verify measurement and deducting payment from a. payment account of the subscriber node and depositing it into a payment account of the publisher node.

In Example 16, the subject matter of any one or more of Examples 14-15 optionally include wherein the information from the publisher node is sent to the digital brokerage service node by a micro compute service agent coupled to the publisher node, the information including criteria for execution within a trusted execution environment.

In Example 17, the subject matter of any one or more of Examples 14-16 optionally includes instructions to: send a request for attestation to a remote attestation service to ensure that criteria for execution within a trusted execution environment on the workload node meets requirements received in the request from a subscriber node.

Example 18 is a publisher node comprising: a micro compute services controller to register available resources, capabilities, and execution environment parameters with a digital brokerage service and to answer queries from a remote attestation service regarding the execution environment parameters; at least one workload node operating in a trusted execution environment; and a micro compute services agent coupled to the micro compute services controller to provision code and/or data objects to the trusted execution environment of the at least one workload node in response to a request for an execution service.

In Example 19, the subject matter of Example 18 optionally includes wherein the micro compute services agent further comprises a trusted loader to securely provision at least one of code or data to the at least one workload node.

In Example 20, the subject matter of any one or more of Examples 18-19 optionally include wherein the micro computer services controller is to register available resources, capabilities, and execution environment parameters to identify its ability to protect data with encryption and to protect execution of code in the at least one workload node operating, wherein available resources are identified as either static or mobile.

In Example 21, the subject matter of Example 20 optionally includes wherein a registered available resource is at least one of data, code, or compute capacity.

In Example 22, the subject matter of any one or more of Examples 20-21 optionally include wherein a registered available compute capacity includes parameters corresponding to available trusted execution environment criteria.

In Example 23, the subject matter of any one or more of Examples 18-22 optionally include wherein the at least one workload node is to notify the digital brokerage service upon completion of a service requested by a subscriber node.

Example 24 is a system comprising: means for accepting by a digital brokerage service node, information from a publisher node to identify resources offered by the publisher node; means for storing into a repository, information associated with the resources offered by the publisher node; means for receiving a request from a subscriber node; heuristically matching data, services and compute resources available from a plurality of publisher nodes, as identified in the repository, to respond to the request received, further to ensure that the matched data, services and compute resources are consistent with a trusted execution environment requirement identified in the request; and means for provisioning data and/or code over a network to a micro compute services controller for service of the request in a trusted execution environment on a workload node, wherein the micro compute services controller comprises a micro compute services agent for provisioning the data or code to the workload node.

In Example 25, the subject matter of Example 24 optionally includes means for receiving notification from the micro compute services agent that the service has been completed; and means for verifying measurement and deducting payment from a payment account of the subscriber node and depositing it into a payment account of the publisher node.

In Example 26, the subject matter of any one or more of Examples 24-25 optionally include wherein the information from the publisher node is sent to the digital brokerage service node by a micro compute service agent coupled to the publisher node, the information including criteria for execution within a trusted execution environment.

In Example 27, the subject matter of Example 26 optionally includes means for sending a request for attestation to a remote attestation service to ensure that criteria for execution within a trusted execution environment on the workload node meets requirements received in the request from a subscriber node.

Example 28 is at least one computer-readable storage medium comprising instructions to perform any of the methods of Examples 10-13.

Example 29 is an apparatus comprising means for performing any of the methods of Examples 10-13.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible, or non-transitory medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked micro compute services, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

In the above Detailed Description, various features may be grouped together or separated to simplify understanding of the disclosure. However, the claims may not set forth every feature disclosed herein as example embodiments, and may instead focus on a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A system for brokering digital services, comprising:
a digital brokerage service server which is communicatively coupled to a network when in operation, the digital brokerage service server to heuristically match a subscriber node with at least one of a plurality of publisher nodes, based on the publisher node capabilities, to ensure that services and data provided remain in a trusted execution environment according to policies required by the subscriber node;
a repository, coupled to the digital brokerage service server when in operation, to hold information received from the plurality of publisher nodes that identify each of the publisher node capabilities and resources offered; and
a transaction service to:
communicate with an attestation service to ensure that the subscriber node and the at least one of the plurality of publisher nodes use a compatible and adequate trusted execution environment, and
effect the matching of data, services and compute to a workload node having the compatible and adequate trusted execution environment.

2. The system as recited in claim 1, wherein the digital brokerage service server is further to:
accept a request from the subscriber node on the network; and
identify available resources from the plurality of publisher nodes on the network.

3. The system as recited in claim 2, wherein the request from subscriber node comprises a subscriber micro compute service package including a header, a plurality of uniform resource identifiers, an executable portion, a key for encryption or decryption, and a signed digest of the subscriber micro compute service package.

4. The system as recited in claim 3, wherein the subscriber micro compute service package further includes an execution policy.

5. The system as recited in claim 4 wherein the execution policy identifies a quality of service required by the subscriber node.

6. The system as recited in claim 5 wherein the quality of service identifies a minimum level for the compatible and adequate trusted execution environment, to be run by the workload node.

7. The system as recited in claim 3, wherein the digital brokerage service server is to facilitate payment for data and services according to a subscriber policy in the subscriber micro compute service package, and the information in the repository.

8. The system as recited in claim 1, wherein to heuristically match the subscriber node with the at least one of a plurality of publisher nodes, comprises the digital brokerage service server to match to at least two separate publisher nodes wherein a first publisher node offers compute capacity in a trusted execution environment, and a second publisher node offers data to be securely transferred to the trusted execution environment.

9. The system as recited in claim 1, wherein the transaction service is further to match data with services based on at least one of: scope of service required, data usage, quality of service requirements, service level agreement constraints, costs, budget, or trusted execution environment requirements.

10. A method of brokering digital services, comprising:
accepting by a digital brokerage service node, information from a publisher node to identify resources offered by the publisher node;
storing into a repository, information associated with the resources offered by the publisher node;
receiving a request from a subscriber node;
heuristically matching data, services and compute resources available from a plurality of publisher nodes, as identified in the repository, to respond to the request received, further to ensure that the matched data, services and compute resources are consistent with a trusted execution environment requirement identified in the request; and
provisioning data and/or code over a network to a micro compute services controller for service of the request in a trusted execution environment on a workload node, wherein the micro compute services controller comprises a micro compute services agent for provisioning the data or code to the workload node.

11. The method as recited in claim 10, further comprising:
receiving notification from the micro compute services agent that the service has been completed; and
verifying measurement and deducting payment from a payment account of the subscriber node and depositing it into a payment account of the publisher node.

12. The method as recited in claim 10, wherein the information from the publisher node is sent to the digital brokerage service node by a micro compute service agent coupled to the publisher node, the information including criteria for execution within the trusted execution environment.

13. The method as recited in claim 12, further comprising:
sending a request for attestation to a remote attestation service to ensure that criteria for execution within the trusted execution environment on the workload node meets requirements received in the request from a subscriber node.

14. At least one computer readable storage medium having instructions stored therein, the instructions when executed to cause a machine to:
accept by a digital brokerage service node, information from a publisher node to identify resources offered by the publisher node;
store into a repository, information associated with the resources offered by the publisher node;
receive a request from a subscriber node;
heuristically match data, services and compute resources available from a plurality of publisher nodes, as identified in the repository, to respond to the request received, further to ensure that the matched data, services and compute resources are consistent with trusted execution environment requirements identified in the request; and
provision data and/or code over a network to a micro compute services controller for service of the request in a trusted execution environment on a workload node, wherein the micro compute services controller comprises a micro compute services agent for provisioning the data or code to the workload node.

15. The medium as recited in claim 14, further comprising instructions to:
receive notification from the micro compute services agent that the service has been completed; and
verify measurement and deducting payment from a payment account of the subscriber node and depositing it into a payment account of the publisher node.

16. The medium as recited in claim 14, wherein the information from the publisher node is sent to the digital brokerage service node by a micro compute service agent coupled to the publisher node, the information including criteria for execution within the trusted execution environment.

17. The medium as recited in claim 16, further comprising instructions to:
send a request for attestation to a remote attestation service to ensure that criteria for execution within the trusted execution environment on the workload node meets requirements received in the request from a subscriber node.

18. A publisher node comprising:
a micro compute services controller to register available resources, capabilities, and execution environment parameters with a digital brokerage service and to answer queries from a remote attestation service regarding the execution environment parameters;
at least one workload node operating in a trusted execution environment; and
a micro compute services agent coupled to the micro compute services controller to provision code and/or data objects to the trusted execution environment of the at least one workload node in response to a request for an execution service.

19. The publisher node as recited in claim 18, wherein the micro compute services agent further comprises a trusted loader to securely provision at least one of code or data to the at least one workload node.

20. The publisher node as recited in claim 18, wherein the micro computer services controller is to register available resources, capabilities, and execution environment parameters to identify its ability to protect data with encryption and to protect execution of code in the at least one workload node operating, wherein available resources are identified as either static or mobile.

21. The publisher node as recited in claim 20, wherein a registered available resource is at least one of data, code, or compute capacity.

22. The publisher node as recited in claim 20, wherein a registered available compute capacity includes parameters corresponding to available trusted execution environment criteria.

23. The publisher node as recited in claim 18, wherein the at least one workload node is to notify the digital brokerage service upon completion of a service requested by a subscriber node.
